(19) United States
(12) Patent Application Publication
(10) Pub. No.: US 2024/0397865 A1
(43) Pub. Date: Dec. 5, 2024

(54) SYSTEMS AND METHODS FOR PHASE CONTROL OF A DUAL KNIFE DRIVE FOR AN AGRICULTURAL HEADER

(71) Applicants: CNH Industrial America LLC, New Holland, PA (US); CNH Industrial Belgium N.V., Zedelgem (CA)

(72) Inventors: Cory Douglas Hunt, Millersville, PA (US); Jethro Martin, Ephrata, PA (US); Christophe Lauwerys, Leuven (BE)

(21) Appl. No.: 18/205,999

(22) Filed: Jun. 5, 2023

(51) Int. Cl. A01D 41/14

(52) U.S. Cl. CPC A01D 41/141; A01D 41/142

(57) ABSTRACT

An agricultural system includes a cutter bar assembly with a first knife section and a second knife section. The agricultural system also includes a drive system associated with the cutter bar assembly and having a first drive assembly configured to drive movement of the first knife section and a second drive assembly configured to drive movement of the second knife section. The agricultural system further includes a controller configured to receive signals indicative of a relative phase between the first drive assembly and the second drive assembly and provide control signals to adjust the relative phase between the first drive assembly and the second drive assembly to maintain the relative phase at a target relative phase.

### BACKGROUND

The present disclosure relates generally to systems and methods for phase control of a dual knife drive for an agricultural header.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A harvester may be used to harvest crops, such as barley, beans, beets, carrots, corn, cotton, flax, oats, potatoes, rye, soybeans, wheat, or other plants. A harvesting process may begin by operating a header of the harvester to remove portions of plants from a field. In some cases, the header may cut the plants to form cut crops and transport the cut crops to a processing system of the harvester.

Certain headers include a cutter bar assembly configured to cut stalks of the plants, thereby separating the cut crops from the soil. The cutter bar assembly may extend along a substantial portion of a width of the header at a forward end of the header. The header may also include one or more belts positioned behind the cutter bar assembly relative to a direction of travel of the harvester. The belt(s) are configured to transport the cut crops to an inlet of the processing system. Certain headers may also include a reel, which may include a reel member having multiple fingers extending from a central framework. The fingers are configured to engage the plants, thereby preparing the plants to be cut by the cutter bar assembly and/or urging the cut crops to move toward the belt(s).

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In certain embodiments, an agricultural system includes a cutter bar assembly with a first knife section and a second knife section. The agricultural system also includes a drive system associated with the cutter bar assembly and having a first drive assembly configured to drive movement of the first knife section and a second drive assembly configured to drive movement of the second knife section. The agricultural system further includes a controller configured to receive signals indicative of a relative phase between the first drive assembly and the second drive assembly and provide control signals to adjust the relative phase between the first drive assembly and the second drive assembly to maintain the relative phase at a target relative phase.

In certain embodiments, an agricultural system includes a controller configured to receive pressure signals from multiple pressure sensors, monitor a first pressure drop across a first motor of a first drive assembly for a first knife section of a cutter bar assembly based on the pressure signals, and monitor a second pressure drop across a second motor of a second drive assembly for a second knife section of the cutter bar assembly based on the pressure signals. The controller is also configured to determine a relative phase between the first motor and the second motor based on the first pressure drop and the second pressure drop and provide control signals to adjust the relative phase between the first motor and the second motor to maintain the relative phase at a target relative phase.

In certain embodiments, a method of operating an agricultural system includes receiving, at a controller, signals indicative of a respective pressure drop across a first motor of a first drive assembly for a first knife section of a cutter bar assembly and indicative of a respective pressure drop across a second motor of a second drive assembly for a second knife section of the cutter bar assembly. The method also includes determining, using the controller, a relative phase between the first motor and the second motor based on the respective pressure drop across the first motor and the respective pressure drop across the second motor. The method further includes providing, using the controller, control signals to adjust the relative phase between the first motor and the second motor to maintain the relative phase at a target relative phase.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an agricultural system, in accordance with an embodiment of the present disclosure;

FIG. 2 is a perspective view of a portion of a header that may be employed within the agricultural system of FIG. 1, in accordance with an embodiment of the present disclosure;

FIG. 3 is a schematic diagram of a drive system for a cutter bar assembly of the header of FIG. 2, in accordance with an embodiment of the present disclosure;

FIG. 4 is a schematic diagram of the drive system of FIG. 3 with pulse sensors, in accordance with an embodiment of the present disclosure;

FIG. 5 is a schematic diagram of a portion of the cutter bar assembly of the header of FIG. 2 with a proximity sensor, in accordance with an embodiment of the present disclosure;

FIG. 6 is a schematic diagram of a portion of the cutter bar assembly of the header of FIG. 2 with a biasing member, in accordance with an embodiment of the present disclosure;

FIG. 7 is a schematic diagram of a portion of the cutter bar assembly of the header of FIG. 2 with an accelerometer, in accordance with an embodiment of the present disclosure;

FIG. 8 is a schematic diagram of the drive system of FIG. 3 with bypass valves and a controller, in accordance with an embodiment of the present disclosure; and

FIG. 9 is a schematic diagram of a drive system for the cutter bar assembly of the header of FIG. 2, wherein the drive system includes a hydraulic manifold and pilot lines, in accordance with an embodiment of the present disclosure.

### DETAILED DESCRIPTION

One or more of the specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming typically begins with placing seeds within a field. Over time, the seeds grow into plants. Often, only a portion of each plant is commercially valuable, so each plant is harvested to separate usable crop material from a remainder of the plant. For example, a harvester may cut plants within the field via a header, which may include a flexible draper header. In particular, the header may include a cutter bar assembly configured to cut the plants to form cut crops. A conveyor coupled to draper deck(s) of the header moves the cut crops toward a crop processing system of the harvester. The crop processing system may include a threshing machine configured to thresh the cut crops, thereby separating the cut crops into certain desired agricultural materials, such as grain, and material other than grain (MOG). The desired agricultural materials may be sifted and then accumulated into a tank. When the tank fills to capacity, the desired agricultural materials may be collected from the tank. The MOG may be discarded from the harvester (e.g., via a spreader) by passing through an exit pipe or a spreader to fall down onto the field.

In some embodiments, portions of the cutter bar assembly may move so as to follow a contour of the field. For example, the cutter bar assembly may be flexible to remain in contact with the field during harvesting operations. Furthermore, the header of the harvester includes a reel (e.g., reel assembly) configured to prepare the plants to be cut by the cutter bar assembly. As an example, the reel may be positioned adjacent to the cutter bar assembly and may be configured to guide the plants toward the cutter bar assembly.

In some embodiments, the cutter bar assembly may include two sections, and each of the two sections is driven by a respective motor. For example, a first section is driven by a first motor, and a second section is driven by a second motor. It is presently recognized that it is desirable to drive the first motor and the second motor such that the first section and the second section both move laterally away from one another, and then both move laterally toward one another to thereby cancel vibrations that may otherwise cause wear on components of the header and/or that may otherwise be felt by an operator of the harvester. Furthermore, it is presently recognized that it is desirable to monitor relative phase of the first motor and the second motor, as well as to provide control signals to the first motor and the second motor to shift the relative phase (e.g., to be out-of-phase). Accordingly, the present disclosure is directed to systems and methods for monitoring and adjusting the relative phase between the first motor and the second motor.

Advantageously, embodiments of the present disclosure may enable monitoring and adjusting the relative phase between the first motor and the second motor continuously (e.g., during harvesting operations; as the harvester travels through the field to harvest crops). Furthermore, embodiments of the present disclosure may enable monitoring and adjusting the relative phase between the first motor and the second motor even without a known, initial phase relationship between the first motor and the second motor (e.g., at start-up). For example, embodiments of the present disclosure do not rely on or utilize a known, initial out-of-phase relationship between the first motor and the second motor and then count respective pulses for the first motor and the second motor (e.g., to keep the count of the respective pulses equal) to maintain the out-of-phase relationship between the first motor and the second motor.

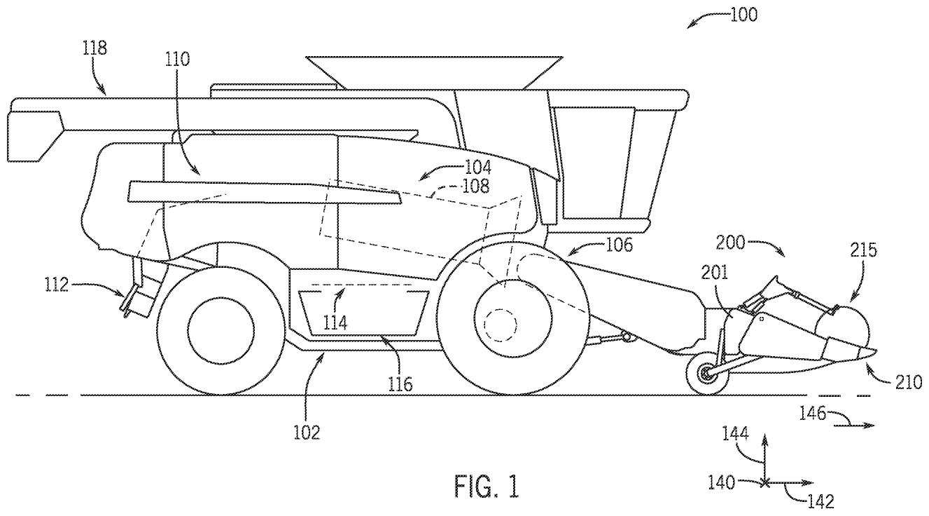

With the foregoing in mind, FIG. 1 is a side view of an embodiment of an agricultural system 100, which may be a harvester. The agricultural system 100 includes a chassis 102 configured to support a header 200 and an agricultural crop processing system 104. The header 200 is configured to cut plants to form cut crops and to transport the cut crops toward an inlet 106 of the agricultural crop processing system 104 for further processing of the cut crops.

The agricultural crop processing system 104 receives the cut crops from the header 200 and separates desired crop material from crop residue. For example, the agricultural crop processing system 104 may include a thresher 108 having a cylindrical threshing rotor that transports the cut crops in a helical flow path through the agricultural system 100. The thresher 108 may also separate the desired crop material (e.g., grain) from the crop residue (e.g., husks and pods), and the thresher 108 may enable the desired crop material to flow into a cleaning system 114 located beneath the thresher 108.

The cleaning system 114 may remove debris from the desired crop material and transport the desired crop material to a storage tank 116 within the agricultural system 100. When the storage tank 116 is full, a tractor with a trailer on the back may pull alongside the agricultural system 100. The desired crop material collected in the storage tank 116 may be carried up by an elevator and dumped out of an unloader 118 into the trailer. The crop residue may be transported from the thresher 108 to a crop residue handling system 110, which may process (e.g., chop/shred) and remove the crop residue from the agricultural system 100 via a crop residue spreading system 112 positioned at an aft end of the agricultural system 100. To facilitate discussion, the agricultural system 100 and/or its components may be described with reference to a lateral axis or direction 140, a longitudinal axis or direction 142, and a vertical axis or direction 144. The agricultural system 100 and/or its components may also be described with reference to a direction of travel 146 (e.g., forward direction of travel).

As discussed in detail below, the header 200 includes a cutter bar assembly 210 configured to cut the plants to form the cut crops. The header 200 also includes a reel 215 (e.g., reel assembly) configured to engage the plants to prepare the plants to be cut by the cutter bar assembly 210 and/or to urge the cut crops onto a conveyor system that directs the cut crops toward the inlet 106 of the agricultural crop processing system 104. The reel 215 includes a reel member having multiple fingers (e.g., tines) extending from a central framework. The central framework is driven to rotate such that the fingers engage and move the plants and the cut crops. The cutter bar assembly 210 and the reel 215 are supported by a frame 201 of the header 200. It should be appreciated the header with the cutter bar assembly and the reel may be employed in any suitable type of harvester or similar machine (e.g., swathers/windrowers that gather the cut crops to form a windrow in the field that is later collected by the harvester).

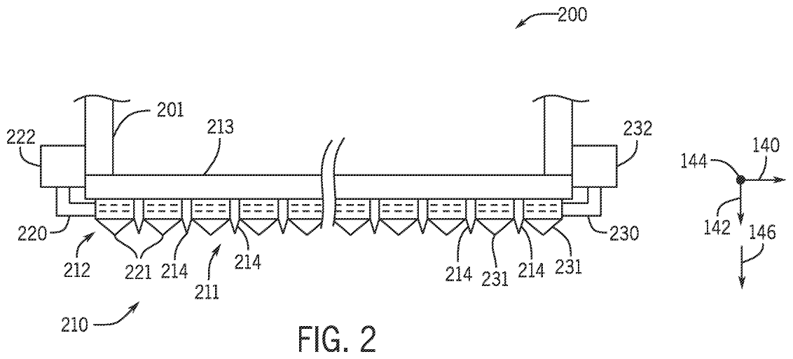

FIG. 2 is a top view of an embodiment of a portion of the header 200. In the illustrated embodiment, the header 200 includes the cutter bar assembly 210 configured to cut the plants, thereby forming the cut crops. The cutter bar assembly 210 is positioned at a forward end of the header 200 relative to the longitudinal axis 142 of the header 200. The cutter bar assembly 210 extends along a substantial portion of the width of the header 200 (e.g., along the lateral axis 140).

The cutter bar assembly 210 includes a stationary guard assembly 211 and a moving knife assembly 212. The stationary guard assembly 211 may include a guard bar 213, which may be coupled (e.g., fixed or rotatably coupled) to the frame 201 of the header 200. Additionally, the stationary guard assembly 211 includes multiple knife guards 214 coupled (e.g., fixed) to the guard bar 213. As shown, the multiple knife guards 214 are spaced apart along the lateral axis 140.

The moving knife assembly 212 is driven to oscillate relative to the stationary guard assembly 211. In particular, the moving knife assembly 212 includes a first knife bar 220 that is coupled (e.g., fixed) to multiple first knives 221, as well as a first drive assembly 222 that drives movement (e.g., oscillation) of the first knife bar 220 and the multiple first knives 221 relative to the stationary guard assembly 211. Additionally, the moving knife assembly 212 includes a second knife bar 230 that is coupled (e.g., fixed) to multiple second knives 231, as well as a second drive assembly 232 that drives movement (e.g., oscillation) of the second knife bar 230 and the multiple second knives 231 relative to the stationary guard assembly 211. Thus, the moving knife assembly 212 includes two sections, including a first section with the first knife bar 220 and the multiple first knives 221 and a second section with the second knife bar 230 and the multiple second knives 231.

The multiple first knives 221 and the multiple second knives 231 are supported between and/or protected by upper and lower portions of the multiple knife guards 214 (e.g., along the vertical axis 144) as the multiple first knives 221 and the multiple second knives 231 oscillate (e.g., along the lateral axis 140) relative to the stationary guard assembly 211. Further, the multiple first knives 221 and the multiple second knives 231 oscillate over a distance equal (e.g., substantially equal) to a space between adjacent knife guards of the multiple knife guards 214 along the lateral axis 140. However, the multiple first knives 221 and the multiple second knives 231 may oscillate over any suitable distance along the lateral axis 140. Each of the multiple first knives 221 and the multiple second knives 231 may have side edges that form sharp, cutting blades that are capable of cutting the plants to form the cut crops in response to engagement with the plants.

The first drive assembly 222 and the second drive assembly 232 may be positioned at or proximate to opposite laterally outer end portions of the header 200. Such positioning may allow effective and efficient movement of the cut crops to the agricultural crop processing system (e.g., does not block flow of the cut crops, particularly as compared to configurations with one or more drive assemblies in or near a center of a header). The first drive assembly 222 may include a first motor and a first device (e.g., gear device, such as rack and pinion) that converts rotary motion from the first motor into linear motion of the first knife bar 220, and the second drive assembly 232 may include a second motor and a second device (e.g., gear device, such as rack and pinion) that converts rotary motion from the second motor into linear motion of the second knife bar 230. The first motor and the second motor may be hydraulic motors that are connected in series.

It is presently recognized that it is desirable for the first drive assembly 222 and the second drive assembly 232 to drive the first knife bar 220 (and the multiple first knives 221 coupled thereto) and the second knife bar 230 (and the multiple second knives 231 coupled thereto) in opposite directions, such that the first knife bar 220 and the second knife bar 230 both move toward one another and then both move away from one another during operation of the header 200. Thus, it is desirable for the first knife bar 220 and the second knife bar 230 to reach respective first end stops (e.g., outer end stops) simultaneously, and then to reach respective second end stops (e.g., inner end stops) simultaneously. To drive the first knife bar 220 and the second knife bar 230 with such opposite reciprocating movement, the first drive assembly 22 and the second drive assembly 232 operate out-of-phase relative to one another (e.g., with respect to position; at a same frequency with opposite phase; fully out-of-phase; 180 degrees). As described herein, such movement cancels vibrations that may otherwise cause wear on components of the header 200 and/or that may otherwise be felt by an operator of the harvester.

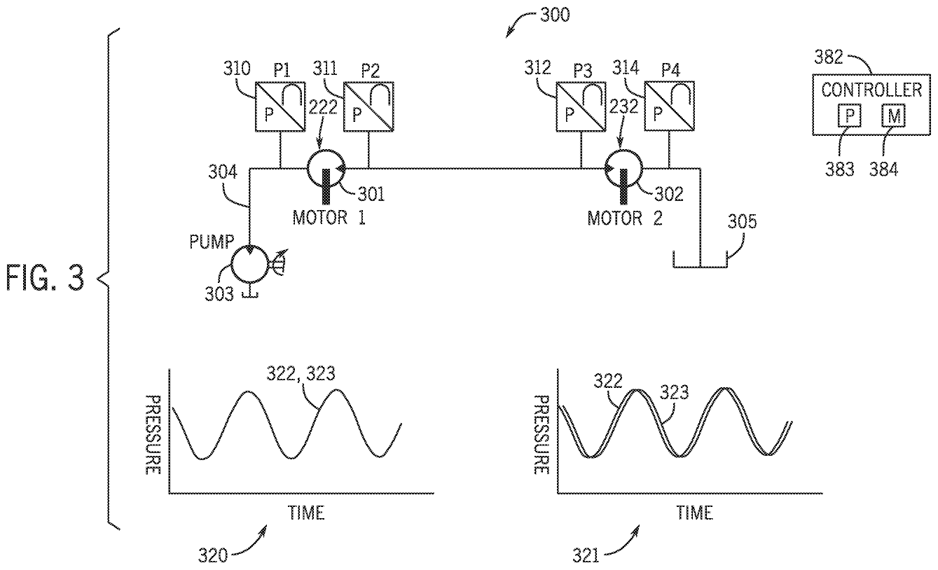

FIG. 3 is a schematic diagram of an embodiment of a drive system 300 for the cutter bar assembly 210 of FIG. 2. The drive system 300 includes a first motor 301 of the first drive assembly 222 and a second motor 302 of the second drive assembly 232. The first motor 301 and the second motor 302 are positioned in series. A pump 303 pumps a fluid (e.g., hydraulic fluid) through a fluid line 304, through the first motor 301 to drive movement of the first knife bar 220 of FIG. 2, through the second motor 302 to drive movement of the second knife bar 230 of FIG. 2, and then to a reservoir 305.

The first motor 301 and the second motor 302 in series are expected to generally operate at equal rotational speed. However, various factors (e.g., variability in load and/or internal leakage) may cause the first motor 301 and/or the second motor 302 to change rotational speed. Accordingly, it is possible for relative phase between the first motor 301 and the second motor 302 to shift or change over time. To address this issue and to facilitate maintaining out-of-phase operation, the drive system 300 includes multiple pressure sensors, such as a first pressure sensor 310, a second pressure sensor 311, a third pressure sensor 312, and a fourth pressure sensor 313.

The multiple pressure sensors 310, 311, 312, 313 enable continuous monitoring of relative phase between the first motor 301 and the second motor 302. In particular, the first pressure sensor 310 and the second pressure sensor 311 detect a respective pressure drop across the first motor 301, while the third pressure sensor 312 and the fourth pressure sensor 313 detect a respective pressure drop across the second motor 302. The respective pressure drop across the first motor 301 is proportional to force acting on the first knife bar 220 of FIG. 2, while the respective pressure drop across the second motor 302 is proportional to force acting on the second knife bar 230 of FIG. 2.

During a single stroke of the first knife bar, the first knife bar is accelerated in a first direction, decelerated to stop at a respective first end stop, then accelerated in a second direction that is opposite the first direction, decelerated to stop at a respective second end stop, and so on. This cycle creates a respective pressure drop signal of roughly sinusoidal shape with equal (e.g., substantially equal) pressure spikes associated with positive peak accelerations at each end stop (e.g., due to a change of direction). The second knife bar may be driven to oscillate between a respective first end stop and a respective second end stop in a similar manner, which creates a respective pressure drop signal of roughly sinusoidal shape with equal (e.g., substantially equal) pressure spikes associated with positive peak accelerations at each end stop.

The pressure drop signals derived from pressure measurements taken by the multiple pressure sensors 310, 311, 312, 313 provide information about the relative phase (e.g., relative phase with respect to position) between the first motor 301 and the second motor 302. For example, when the pressure spikes of the pressure drop signals are aligned (in time), the first motor 301 and the second motor 302 are either in-phase or fully out-of-phase. Further, when the pressure spikes of the pressure drop signals are slightly misaligned, the first motor 301 and the second motor 302 are either nearly in-phase or nearly out-of-phase.

However, because the pressure drop signals indicate positive peak accelerations at each end stop, the pressure drop signals alone do not indicate whether the first motor 301 and the second motor 302 are in-phase or out-of-phase. Similarly, the pressure drop signals alone do not indicate whether the first motor 301 and the second motor 302 are nearly in-phase or nearly out-of-phase. For example, graph 320 illustrates the pressure drop signals 322, 323 are aligned with one another, which indicates that the first motor 301 and the second motor 302 are either in-phase or out-of-phase. Similarly, graph 321 illustrates the pressure drop signals 322, 323 are slightly misaligned with one another, which may indicate that the first motor 301 and the second motor 302 are either nearly in-phase or nearly out-of-phase. Accordingly, the pressure drop signals may be considered in conjunction with other information, such as pulse detections, vibrations, and so forth, to determine whether the first motor 301 and the second motor 302 are in-phase or out-of-phase, as well as whether the first motor 301 and the second motor 302 are nearly in-phase or nearly out-of-phase.

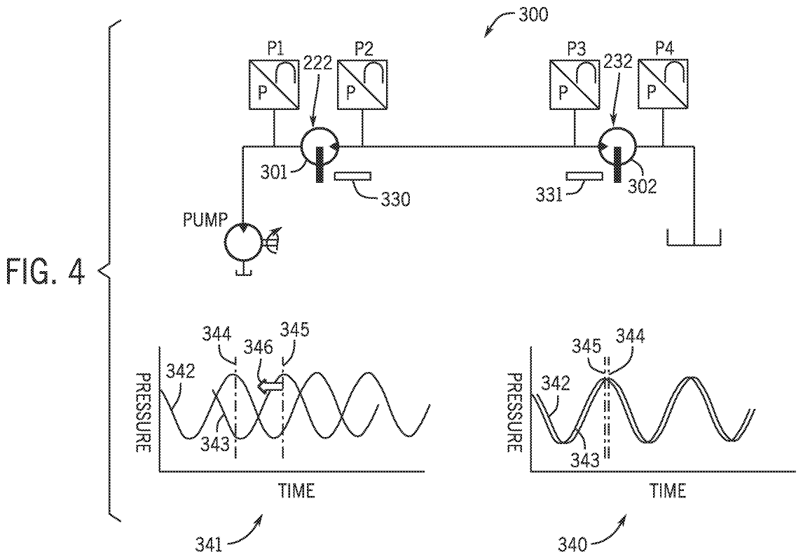

FIG. 4 is a schematic diagram of an embodiment of the drive system 300 for the cutter bar assembly 210 of FIG. 2, wherein the drive system 300 includes a first pulse sensor 330 associated with the first drive assembly 222 and a second pulse sensor 331 associated with the second drive assembly 232. In some such cases, the first drive assembly 222 may include a first detectable marker (e.g., protrusion or tooth, such as on a first drive wheel) that rotates with a respective output shaft of the first motor 301, and the second drive assembly 232 may include a second detectable marker (e.g., protrusion or tooth, such as on a second drive wheel) that rotates with a respective output shaft of the second motor 302. The first pulse sensor 330 may be configured to detect the first detectable marker to count a respective pulse per rotation of the respective output shaft of the first motor 301. Similarly, the second pulse sensor 331 may be configured to detect the second detectable marker to count a respective pulse per rotation of the respective output shaft of the second motor 302.

The first detectable marker and the second detectable marker may have known relationships to movement of the first knife bar and the second knife bar, respectively. For example, the first detectable marker may pass the first pulse sensor 330 when the first knife bar is at a respective first end stop, while the second detectable marker may pass the second pulse sensor 331 when the second knife bar is at a respective first end stop. Thus, the pressure drop signals in combination with detecting one respective pulse per rotation in this way may indicate the relative phase (e.g., with respect to position) between the first motor 301 and the second motor 302, such as whether the first motor 301 and the second motor 302 are in-phase or out-of-phase, as well as whether the first motor 301 and the second motor 302 are nearly in-phase or nearly out-of-phase. Then, if the first motor 301 and the second motor 302 are not out-of-phase, as desired, appropriate adjustments may be carried out to shift phase of one of the motors 301, 302 to return the first motor 301 and the second motor 302 to be out-of-phase.

For example, with reference to graph 340 of FIG. 4, the pressure drop signals 342, 343 in combination with respective pulse per rotation indicators 344, 345 indicate that the first motor 301 and the second motor 302 are nearly out-of-phase. However, with reference to graph 341 of FIG. 4, the pressure drop signals 342, 343 in combination with the respective with the respective pulse per rotation indicators 344, 345 indicate that the first motor 301 and the second motor 302 are nearly in-phase. This may inform the appropriate adjustments to shift phase of one of the motors 301, 302 (e.g., in an appropriate direction) to return the first motor 301 and the second motor 302 to be out-of-phase. For example, as shown overlaid onto the graph 340, the appropriate adjustments may include to shift phase of the second motor 302 as shown by arrow 346.

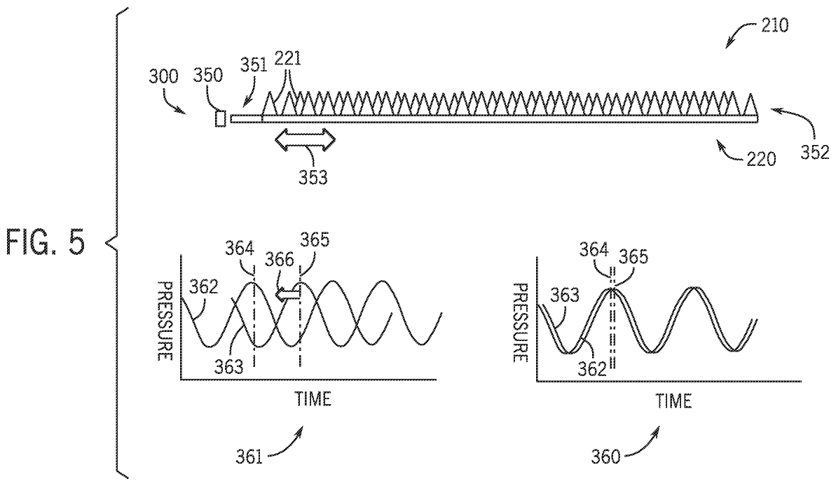

FIG. 5 is a schematic diagram of an embodiment of the cutter bar assembly 210, wherein the drive system 300 includes or is communicatively coupled to a first proximity sensor 350. The first proximity sensor 350 may be configured to detect each occurrence of the first knife bar 220 (and the multiple first knives 221 coupled thereto) reaching the respective first end stop, which may be at or near a laterally-outer edge of the header. For example, the first knife bar 220 oscillates between a first position 351 and a second position 352, as shown by arrow 353. Each time the first knife bar 220 reaches the first position 351, the first proximity sensor 350 will detect the first knife bar 220 and mark one occurrence of the first knife bar 220 reaching the first end stop. It should be appreciated that the drive system 300 includes or is communicatively coupled to a second proximity sensor that operates in a same or similar manner to mark each occurrence of the second knife bar (and the multiple second knives coupled thereto) reaching the respective first end stop, which may be at or near a laterally-outer edge of the header.

The pressure drop signals in combination with detecting each occurrence of the first knife bar 220 and the second knife bar reaching their respective end stops may indicate the relative phase between the first motor 301 and the second motor 302, such as whether the first motor 301 and the second motor 302 are in-phase or out-of-phase, as well as whether the first motor 301 and the second motor 302 are nearly in-phase or nearly out-of-phase. Then, if the first motor 301 and the second motor 302 are not out-of-phase, as desired, appropriate adjustments may be carried out to shift phase of one of the motors 301, 302 to return the first motor 301 and the second motor 302 to be out-of-phase.

For example, with reference to graph 360 of FIG. 5, the pressure drop signals 362, 363 in combination with detecting each occurrence 364, 365 of the first knife bar 220 and the second knife bar reaching their respective end stops indicate that the first motor 301 and the second motor 302 are nearly out-of-phase. However, with reference to graph 361 of FIG. 4, the pressure drop signals 362, 363 in combination with detecting each occurrence 364, 365 of the first knife bar 220 and the second knife bar reaching their respective end stops indicate that the first motor 301 and the second motor 302 are nearly in-phase. This may inform the appropriate adjustments to shift phase of one of the motors 301, 302 (e.g., in an appropriate direction) to return the first motor 301 and the second motor 302 to be out-of-phase. For example, as shown overlaid onto the graph 360, the appropriate adjustments may include to shift phase of the second motor 302 as shown by arrow 366.

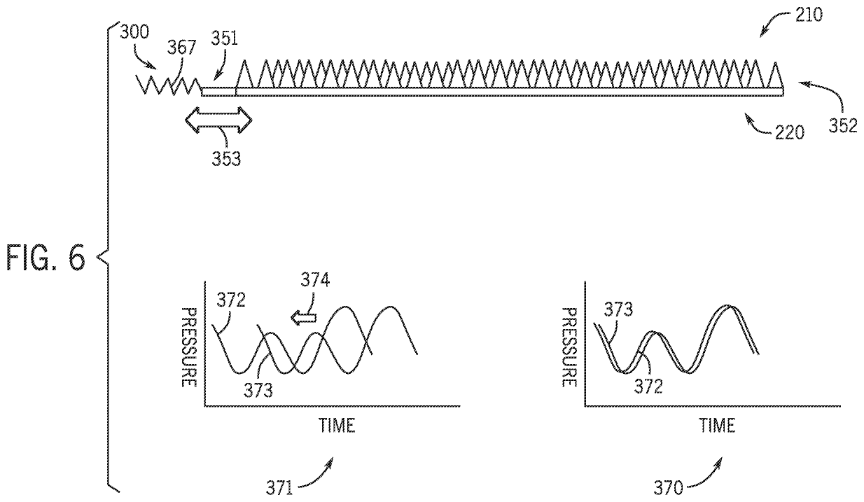

FIG. 6 is a schematic diagram of an embodiment of the cutter bar assembly 210, wherein the drive system 300 includes or is communicatively coupled to a first biasing member 367 (e.g., spring). The first knife bar 220 oscillates between the first position 351 to the second position 352, as shown by the arrow 353. Each time the first knife bar 220 reaches the first position 351 at the respective first end stop, the first biasing member 367 contacts the first knife bar 220 and biases the force applied by the first drive assembly to be greater in either a push or pull direction, thereby creating an uneven pressure signature in the pressure drop signal associated with the first motor. It should be appreciated that the drive system 300 includes or is communicatively coupled to a second biasing member that operates in a same or similar manner to contact the second knife bar at the respective first end stop and bias the force applied by the second drive assembly to be greater in either a push or pull direction, thereby creating an uneven pressure signature in the pressure drop signal associated with the second motor.

The pressure drop signals with the uneven pressure signatures indicate the relative phase between the first motor 301 and the second motor 302, such as whether the first motor 301 and the second motor 302 are in-phase or out-of-phase, as well as whether the first motor 301 and the second motor 302 are nearly in-phase or nearly out-of-phase. Then, if the first motor 301 and the second motor 302 are not out-of-phase, as desired, appropriate adjustments may be carried out to shift phase of one of the motors 301, 302 to return the first motor 301 and the second motor 302 to be out-of-phase.

For example, with reference to graph 370 of FIG. 6, the pressure drop signals 372, 373 with the uneven pressure signatures indicate that the first motor 301 and the second motor 302 are nearly out-of-phase. However, with reference to graph 371 of FIG. 5, the pressure drop signals 372, 373 with the uneven pressure signatures indicate that the first motor 301 and the second motor 302 are nearly in-phase. This may inform the appropriate adjustments to shift phase of one of the motors 301, 302 (e.g., in an appropriate direction) to return the first motor 301 and the second motor 302 to be out-of-phase. For example, as shown overlaid onto the graph 370, the appropriate adjustments may include to shift phase of the second motor 302 as shown by arrow 374.

Returning to FIG. 3, it should be appreciated that the third pressure sensor 312 may be omitted in certain cases. For example, if fluid loss along the fluid line 304 is treated as negligible or if the fluid loss can be determined via other techniques (e.g., based on experimental data and/or models), then one pressure sensor (e.g., the second pressure sensor 311) between the first motor 301 and the second motor 302 may be sufficient to determine the pressure drop signals for the first motor 301 and the second motor 302. In such cases, the pressure measured by the second pressure sensor 311 may be utilized as an upstream pressure for the second motor 302. Further, both the third pressure sensor 312 and the fourth pressure sensor 313 may be omitted in certain cases. For example, if there is negligible restriction between the second motor 302 and the reservoir 305, it can be assumed that a downstream pressure for the second motor 302 is atmospheric pressure (e.g., 1 atm).

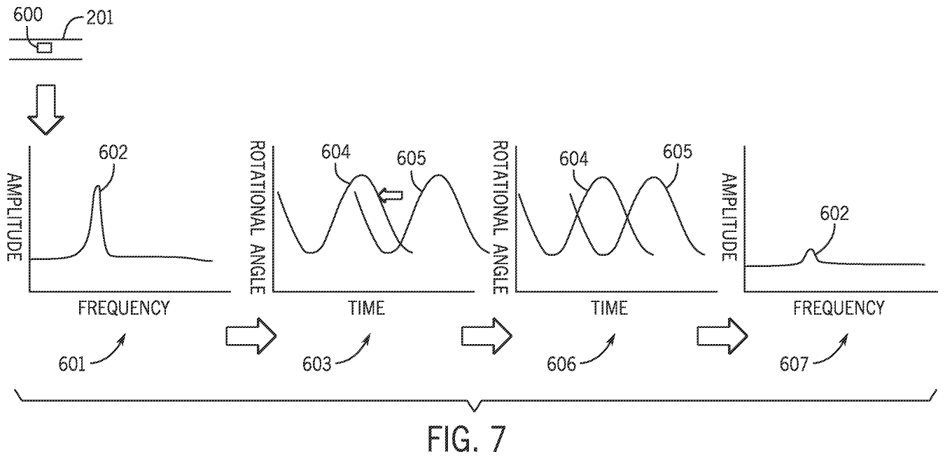

FIG. 7 is a schematic diagram of an embodiment of a portion of the cutter bar assembly with an accelerometer 610 (e.g., only one or single accelerometer) mounted to the frame 201 of the cutter bar assembly. In particular, the accelerometer 600 may detect vibrations indicative of relative phase of the first motor and the second motor of the drive system for the cutter bar assembly. For example, with a known approximation of an operating speed, a band of frequencies may be selected and evaluated to determine the relative phase of the first motor and the second motor. With reference to graph 601, a peak 602 indicates the relative phase of the first motor and the second motor (e.g., the amplitude of the peak 602 indicates a degree with which the first motor and the second motor are not out-of-phase, as desired; a high amplitude of the peak 602, such as over a threshold, indicates that the first motor and the second motor are not out-of-phase, as desired).

In response to the amplitude of the peak 602 being over the threshold, the relative phase of the first motor 301 and the second motor 301 may be adjusted until the amplitude of the peak 602 reaches a target amplitude (e.g., below the threshold or some other threshold; a minimum amplitude). It may be advantageous to shift the relative phase in one direction by a small amount, assess signals from the accelerometer 600 to determine whether the vibration increased or decreased (as indicated by the amplitude of the peak 602 increasing or decreasing, respectively), and then either continue to shift the relative phase in a same direction if the vibration decreased or change to shift the relative phase in an opposite direction if the vibration increased.

Graph 603 illustrates the relative phase of the first motor (first line 604) and the second motor (second line 605) that corresponds to the graph 601. Graph 606 illustrates the relative phase of the first motor (the first line 604) and the second motor (the second line 605) after shift in the relative phase to operate the first motor and the second motor out-of-phase. Further, graph 607 illustrates the signals from the accelerometer 600 with the peak 602 at the target amplitude that is achieved with the first motor and the second motor out-of-phase.

It should be appreciated that other acceleration-based techniques may be implemented to facilitate out-of-phase operations. For example, a first accelerometer may be mounted to the first knife bar and a second accelerometer may be mounted to the second knife bar to facilitate out-of-phase operations. In some embodiments, the first accelerometer may be mounted to another component that oscillates with the first knife bar and/or is included within or mechanically connected to the first drive assembly (e.g., gearbox of the first drive assembly). Similarly, in some embodiments, the second accelerometer may be mounted to another component that oscillates with the second knife bar and/or is included within or mechanically connected to the second drive assembly (e.g., gearbox of the second drive assembly).

In such cases, the first accelerometer and the second accelerometer provide two signals indicative of vibration, which enable determination of relative phase of a particular frequency content of the vibration. Then, the relative phase may be monitored over time and adjustments carried out to maintain the relative phase at 180 degrees (e.g., out-of-phase) for the particular frequency content of the vibration that is associated with the drive system. The relative phase monitored over time in this way enables an appropriate adjustment (e.g., degree, delay).

Further, one aspect of these techniques is that the relative phase may be maintained at a particular value (e.g., 180 degrees, 90 degrees), which may be determined or selected based on conditions. For example, it may be desirable to maintain the relative phase at 90 degrees to reduce a cutting load on the cutter bar assembly (e.g., the multiple first knives and the multiple second knives cut the plants at slightly different times; as compared to the relative phase at 180 degrees).

Thus, if the cutting load exceeds (or is expected to exceed) a load threshold with the relative phase at 180 degrees, it may be desirable to instead operate with the relative phase at 90 degrees to reduce the cutting load even if this results in increased vibrations (e.g., as compared to the relative phase at 180 degrees). Thus, in light crop, the relative phase may be maintained at a first relative phase target (e.g., 180 degrees), while, in heavy crop, the relative phase may be maintained at a second relative phase target (e.g., 90 degrees). The drive system may set and maintain various relative phase targets based on other conditions, such as power limitations, cutting load at start-up (e.g., to reduce start-up torque), and so forth. For example, the drive system may begin with the relative phase target at 90 degrees for a period of time after start-up, and then switch to the relative phase target at 180 degrees following the period of time. Thus, it should be appreciated that the relative phase target(s) may be adjustable, such as by the controller based on conditions, operator inputs provided to the controller, and/or both. For example, different operators may have different tolerance for vibrations (e.g., some operators may prefer to always minimize vibrations by operating at 180 degrees).

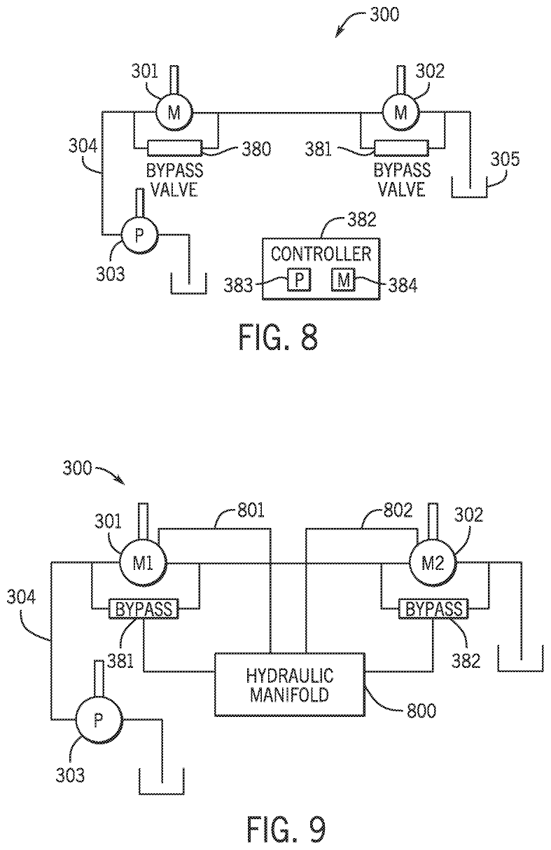

FIG. 8 illustrates an embodiment of the drive system 300 with the first motor 301 and the second motor 302. The drive system 300 includes the pump 303 that is configured to pump the fluid into the fluid line 304. As shown, the drive system 300 also includes a first bypass valve 380 and a second bypass valve 381 that are controlled by a controller 382 (e.g., electronic controller 382). The controller 382 includes a processor 383 and a memory device 384.

The controller 382 is configured to receive signals (e.g., data, information), such as signals indicative of pressure from multiple pressure sensors, signals indicative of pulses from multiple pulse sensors, signals indicative of proximity of the first knife bar and/or the second knife bar from multiple proximity sensors, signals indicative of acceleration from one or more accelerometers, and/or any other suitable sensors, and/or any combination thereof. The controller 382 is configured to process the signals to determine various operational parameters, such as the relative phase of the first motor 301 and the second motor 302. Further, the controller 382 is configured to provide control signals to control the pump 303, the first bypass valve 380, the second bypass valve 381, and/or any other suitable devices, and/or any combination thereof. As described herein, the controller 382 may receive and process the signals, as well as provide the control signals, to maintain the relative phase between the first motor 301 and the second motor 302 at a relative phase target (e.g., out-of-phase). For example, the controller 382 may receive and process the signals, as well as provide the control signals, to maintain the relative phase between the first motor 301 and the second motor 302 at the relative phase target as the cutter bar assembly cuts the plants to form the cut crops during operation of the harvester (e.g., during travel through the field). Advantageously, the controller 382 may maintain the relative phase between the first motor 301 and the second motor 302 using the techniques described herein without a known, initial phase relationship between the first motor 301 and the second motor 302 (e.g., at start-up).

In response to the controller 382 determining that the relative phase between the first motor 301 and the second motor 302 does not match the relative phase target, the controller 382 may provide the control signals to adjust the first bypass valve 380 and/or the second bypass valve 381. For example, while maintaining the second bypass valve 381 in a respective closed position, the controller 382 may adjust the first bypass valve 380 from a respective closed position to a respective open position to enable the fluid to flow through the first bypass valve 380 to bypass the first motor 301. Then, the fluid that bypasses the first motor 301 reaches the second motor 302, and thus the fluid acts to slow the first motor 301 relative to the second motor 302. As another example, while maintaining the first bypass valve 380 in the respective closed position, the controller 382 may adjust the second bypass valve 381 from the respective closed position to a respective open position to enable the fluid to flow through the second bypass valve 381 to bypass the second motor 302. The fluid flows through the first motor 301, but is diverted away from the second motor 302 to the reservoir 305 (e.g., does not pass through the second motor 302), and thus the fluid acts to slow the second motor 302 relative to the first motor 301. In this manner, the controller 382 may operate the first bypass valve 380 and the second bypass valve 381 to adjust the relative phase between the first motor 301 and the second motor 302. It should be appreciated that the drive system 300 may only include one bypass valve, such as only the first bypass valve 380 (and not the second bypass valve 381).

The controller 382 may also include one or more storage devices and/or other suitable components. The processor 383 may be used to execute software, such as software for processing signals, generating control signals, and/or other aspects. Moreover, the processor 383 may include multiple microprocessors, one or more “general-purpose” microprocessors, one or more special-purpose microprocessors, and/or one or more application specific integrated circuits (ASICS), or some combination thereof. For example, the processor 383 may include one or more reduced instruction set (RISC) or complex instruction set (CISC) processors. The memory device 384 may include a volatile memory, such as random access memory (RAM), and/or a nonvolatile memory, such as read-only memory (ROM). The memory device 384 may store a variety of information and may be used for various purposes. For example, the memory device 384 may store processor-executable instructions (e.g., firmware or software) for the processor 383 to execute, such as instructions for processing sensor signals, generating control signals, and/or other aspects. The memory device 384 and/or the processor 383, or an additional memory and/or processor, may be located in any suitable portion of the agricultural system. By way of example, the controller 382 may be located in a cab of the agricultural system and/or on the header.

FIG. 9 is a schematic diagram of an embodiment of the drive system 300 with a hydraulic manifold 800. The drive system 300 also includes the first motor 301, the second motor 302, the pump 303 that is configured to pump the fluid into the fluid line 304, the first bypass valve 380, and the second bypass valve 381. As shown, a first pilot line 801 (e.g., port) may extend from the first motor 301 to the hydraulic manifold 800, and a second pilot line 802 (e.g., port) may extend from the second motor 302 to the hydraulic manifold.

The first pilot line 801 may be exposed to operating pressure of the pump 303 during a portion of a rotation of the first motor 301 (e.g., only during the portion). Similarly, the second pilot line 802 may be exposed to operating pressure of the pump 303 during a portion of a rotation of the second motor 302 (e.g., only during the portion). In this way, the first and second pilot lines 801, 802 may control one or more valves in the hydraulic manifold 800 such that the first and second bypass valves 380, 381 are opened or closed via pilot pressure from the first and second pilot lines 801, 802 in response to the relative phase between the first motor 301 and the second motor 302 causing high pilot pressure from both the first and second pilot lines 801, 802 (e.g., only when the first motor 301 and the second motor 302 are not out-of-phase; in response to the first motor 301 and the second motor 302 shifting from being out-of-phase).

As a more particular example, if the second motor 302 slowed down to cause its phase to shift relative to the first motor 301, the first motor 301 and the second motor 302 would output high pressure to the first pilot line 801 and the second pilot line, respectively, for some period of time. This would cause the one or more valves in the hydraulic manifold 800 to direct pressure to the first bypass valve 380, which in turn would cause some volume of the fluid to bypass the first motor 301 during every rotation of the first motor 301 and eventually slow down to return to a correct phase (e.g., to be out-of-phase with the second motor 302).

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that any features illustrated in FIGS. 1-9 and/or described with reference to FIGS. 1-9 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural system, comprising:
a cutter bar assembly comprising a first knife section and a second knife section;
a drive system associated with the cutter bar assembly and comprising a first drive assembly configured to drive movement of the first knife section and a second drive assembly configured to drive movement of the second knife section; and
a controller configured to:
receive signals indicative of a relative phase between the first drive assembly and the second drive assembly; and
provide control signals to adjust the relative phase between the first drive assembly and the second drive assembly to maintain the relative phase at a target relative phase.

2. The agricultural system of claim 1, wherein the signals are indicative of a respective pressure drop across a first motor of the first drive assembly and a respective pressure drop across a second motor of the second drive assembly.

3. The agricultural system of claim 2, comprising a first pressure sensor positioned upstream of the first motor and a second pressure sensor positioned downstream of the first motor, wherein the signals from the first pressure sensor and the second pressure are indicative of the respective pressure drop across the first motor.

4. The agricultural system of claim 3, comprising a third pressure sensor positioned upstream of the second motor and a fourth pressure sensor positioned downstream of the second motor, wherein the signals from the third pressure sensor and the fourth pressure are indicative of the respective pressure drop across the second motor.

5. The agricultural system of claim 2, comprising a first pulse sensor configured to detect a single pulse per rotation of the first motor and a second pulse sensor configured to detect a single pulse per rotation of the second motor, wherein the controller is configured to determine the relative phase between the first drive assembly and the second drive assembly based on the respective pressure drop across the first motor, the respective pressure drop across the second motor, the single pulse per rotation of the first motor, and the single pulse per rotation of the second motor.

6. The agricultural system of claim 2, comprising a first proximity sensor configured to detect respective occurrences of the first knife section reaching a respective first end stop and a second proximity sensor configured to detect respective occurrences of the second knife section reaching a respective first end stop, wherein the controller is configured to determine the relative phase between the first drive assembly and the second drive assembly based on the respective pressure drop across the first motor, the respective pressure drop across the second motor, the respective occurrences of the first knife section reaching the respective first end stop, and the respective occurrences of the second knife section reaching the respective first end stop.

7. The agricultural system of claim 2, comprising a first biasing member configured to contact the first knife section at a respective first end stop and a second biasing member configured to contact the second knife section at a respective first end stop, wherein the controller is configured to determine the relative phase between the first drive assembly and the second drive assembly based on the respective pressure drop across the first motor and the respective pressure drop across the second motor.

8. The agricultural system of claim 1, comprising a bypass valve, wherein the controller is configured to provide the control signals to adjust the bypass valve from a closed position to an open position slow a first motor of the first drive assembly to adjust the relative phase between the first drive assembly and the second drive assembly to maintain the relative phase at the target relative phase.

9. The agricultural system of claim 1, wherein the first knife section comprises a first knife bar that supports a plurality of first knives configured to cut plants to form cut crops, and the second knife section comprises a second knife bar that supports a plurality of second knives configured to cut the plants to form the cut crops.

10. The agricultural system of claim 1, wherein the first knife section and the second knife section extend laterally across a header of the agricultural system.

11. The agricultural system of claim 1, wherein the controller is configured to maintain the relative phase at the target relative phase without receiving a known, initial relative phase at start-up.

12. The agricultural system of claim 1, wherein a first motor of the first drive assembly and a second motor of the second drive assembly are in series.

13. The agricultural system of claim 1, wherein the first drive assembly and the second drive assembly are positioned on opposite lateral sides of the cutter bar assembly.

14. The agricultural system of claim 1, wherein the controller is configured to adjust the target relative phase based on conditions, operator input, or both.

15. The agricultural system of claim 1, comprising an accelerometer that generates the signals, wherein the controller is configured to compare an amplitude of the signals to a threshold to determine the relative phase between the first drive assembly and the second drive assembly.

16. An agricultural system, comprising:
a controller configured to:
receive pressure signals from a plurality of pressure sensors;
monitor a first pressure drop across a first motor of a first drive assembly for a first knife section of a cutter bar assembly based on the pressure signals;
monitor a second pressure drop across a second motor of a second drive assembly for a second knife section of the cutter bar assembly based on the pressure signals;
determine a relative phase between the first motor and the second motor based on the first pressure drop and the second pressure drop; and
provide control signals to adjust the relative phase between the first motor and the second motor to maintain the relative phase at a target relative phase.

17. The agricultural system of claim 16, where in the controller is configured to:
receive additional signals from one or more additional sensors; and
determine the relative phase between the first motor and the second motor based on the first pressure drop, the second pressure drop, and the additional signals.

18. The agricultural system of claim 17, wherein the additional signals are indicative of occurrences of the first knife section reaching a respective first end stop and the second knife section reaching a respective first end stop.

19. The agricultural system of claim 16, wherein the pressure signals reflect variations over time due to biasing force applied to the first knife section and the second knife section by biasing members.

20. A method of operating an agricultural system, the method comprising:
receiving, at a controller, signals indicative of a respective pressure drop across a first motor of a first drive assembly for a first knife section of a cutter bar assembly and indicative of a respective pressure drop across a second motor of a second drive assembly for a second knife section of the cutter bar assembly;
determining, using the controller, a relative phase between the first motor and the second motor based on the respective pressure drop across the first motor and the respective pressure drop across the second motor; and
providing, using the controller, control signals to adjust the relative phase between the first motor and the second motor to maintain the relative phase at a target relative phase.
